(19) United States
(12) Patent Application Publication
(10) Pub. No.: US 2025/0267485 A1
(43) Pub. Date: Aug. 21, 2025

(54) METHOD IMPLEMENTED IN A TELECOMMUNICATION NETWORK AND ASSOCIATED ELECTRONIC UNITS

(71) Applicant: FONDATION B-COM, Cesson Sevigne (FR)

(72) Inventor: Thierry LUCIDARME, Livré-sur-Changeon (FR)

(21) Appl. No.: 19/057,722

(22) Filed: Feb. 19, 2025

(30) Foreign Application Priority Data
Feb. 20, 2024 (FR) 2401670

(51) Int. Cl. H04W 24/08

(52) U.S. Cl. CPC H04W 24/08

(57) ABSTRACT

In a telecommunication network including at least one management infrastructure electrically powered by at least one electrical energy supplier via an electrical grid, a method includes receiving, by an electronic unit connected to the telecommunication network, data representative of the distribution, by type of production energy source, of the electric power produced by the electrical energy supplier or available on the electrical grid, testing, by the electronic unit, at least one condition relating to the distribution, and when the at least one condition is met, adapting the operation of the electronic unit or of another electronic unit connected to the telecommunication network.

### TECHNICAL FIELD OF THE INVENTION

The present invention relates to the technical field of telecommunication networks. It more particularly relates to a method implemented in a telecommunication network, as well as associated electronic units.

### STATE OF THE ART

Telecommunication networks are commonly used today to connect user equipment (such as cell phones) designed to establish a link with the relevant telecommunication network.

Within the framework of mobile phone networks, it has been proposed (for example in the technical report 3GPP TR 23.700-66 V0.2.0) to provide certain network entities with information on energy consumption, in particular information on CO₂ emissions and renewable energies.

### DISCLOSURE OF THE INVENTION

In this context, it is provided a method implemented in a telecommunication network comprising at least one management infrastructure electrically powered by at least one electrical energy supplier via an electrical grid, this method comprising the following steps:
receiving, by an electronic unit connected to the telecommunication network, data representative of the distribution, by type of production energy source, of the electric power produced by the electrical energy supplier or available on the electrical grid;
testing, by the electronic unit, at least one condition relating to said distribution;
when said at least one condition is met, adapting operation of the electronic unit or of another electronic unit connected to the telecommunication network.

The electronic unit operation can thus be adapted as a function of the distribution (sometimes called “energy mix”) defined in the representative data, by adopting for example a less energy-consuming configuration, when fossil or non-renewable energies are over-utilized.

The electronic unit can be a user equipment designed to establish a radio link with the telecommunication network.

The adaptation step can in this case be a step of adapting this electronic unit.

In a conceivable embodiment, the method can comprise the following steps:
receiving, by the electronic unit, other data representative of another distribution, by type of production energy source, of an electric power powering at least partly another telecommunication network;
connecting the electronic unit to the telecommunication network or to the other telecommunication network as a function of said distribution and said other distribution.

According to other possible embodiments (possibly combinable):
the frequency bands usable by the electronic unit to establish said radio link can be determined as a function of said distribution;
the electronic unit can determine the network slice via which it accesses the telecommunication network as a function of said distribution;
the maximum transmission power of the electronic unit can be modified as a function of said distribution;
the services available for execution by the electronic unit can be determined as a function of said distribution.

The representative data can be received by the electronic unit within a block of system information.

Moreover, the electronic unit can be equipped with a subscriber identification module; this subscriber identification module can in this case store data indicative of said at least one condition.

The electronic unit can be an infrastructure unit of the telecommunication network.

Such an electronic unit can for example be designed to establish a radio link with at least one user equipment.

The method can in this case comprise the following steps:
establishing, by the electronic unit and as a function of said distribution, a list of network slices usable by the user equipment;
transmitting said list from the electronic unit to the user equipment.

The user equipment can then be designed to select a network access slice among the network slices of the list. The user equipment can thus access the telecommunication network via the selected network slice.

In other words, the electronic unit can be designed so as, when said at least one condition is met, to transmit to the other electronic unit data causing an adaptation of the other electronic unit operation.

According to other possible embodiments, that can be combined with the previous ones:
the adaptation can comprise postponing the execution of a task when said at least one condition is met;
said task can be an updating of a software component of the electronic unit;
the adaptation can comprise selecting a predefined algorithm to implement a given functionality;
the adaptation can comprise modifying the location, within the telecommunication network, of buffers used by user equipment connected to the telecommunication network.

Said at least one condition is met for example when said distribution indicates an electric power portion obtained from fossil energies that is higher than a predetermined threshold. According to another possible embodiment, said at least one condition is met when said distribution indicates an electric power portion derived from wind (or an increase of this portion) that is higher than a predetermined threshold.

Moreover, said representative data can be transmitted by a server associated with the electrical energy supplier or the electrical grid. Said representative data can also be transmitted via an operation, administration and maintenance architecture associated with the telecommunication network and/or via at least one management function of the telecommunication network.

The invention also proposes an electronic unit comprising:
a communication module configured to establish a link with a telecommunication network comprising at least one management infrastructure electrically powered by at least one electrical energy supplier via an electrical grid, and to receive data representative of the distribution, by type of production energy source, of the electric power produced by the electrical energy supplier or available on the electrical grid; and
an adaptation module configured to test at least one condition relating to said distribution and to adapt, when said at least one condition is met, operation of the electronic unit.

As already indicated, this electronic unit can be a user equipment; the communication module can be configured to establish a radio link with the telecommunication network.

The invention also proposes an electronic unit comprising:
a communication module configured to establish a link with a telecommunication network comprising at least one management infrastructure electrically powered by at least one electrical energy supplier via an electrical grid, and to receive data representative of the distribution, by type of production energy source, of the electric power produced by the electrical energy supplier or available on the electrical grid; and
an adaptation module configured to test at least one condition relating to said distribution and to control, when said at least one condition is met, the transmission (for example by means of a communication unit distinct from the above-mentioned communication module), to another electronic unit connected to the telecommunication network, of data causing an adaptation of operation of this other electronic unit.

This other electronic unit can be for example a user equipment having established a radio link with the above-mentioned communication unit.

### DETAILED DESCRIPTION OF THE INVENTION

Moreover, various other characteristics of the invention will be apparent from the appended description made with reference to the drawings that illustrate non-limiting embodiments of the invention, and wherein:

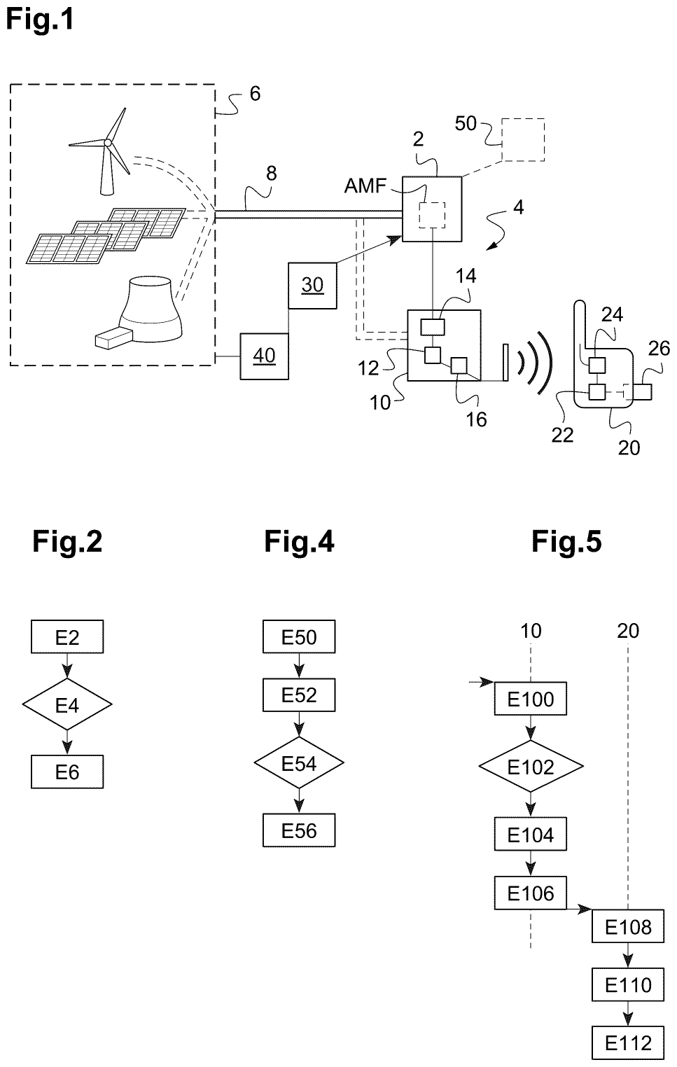

FIG. 1 is a diagram of an example of a context in which the invention can be implemented;

FIG. 2 is a flow chart showing a first example of a method according to the invention;

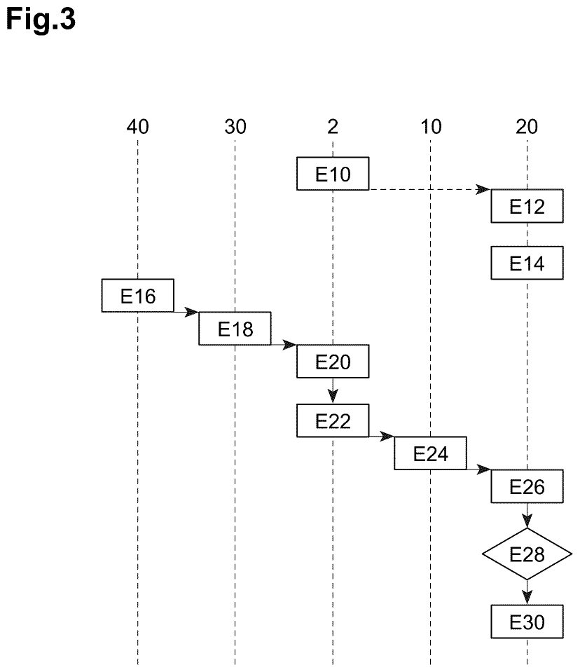

FIG. 3 is a flow chart showing a second example of a method according to the invention;

FIG. 4 is a flow chart showing a third example of a method according to the invention; and

FIG. 5 is a flow chart showing a fourth example of a method according to the invention.

FIG. 1 shows an example of context in which the invention can be implemented.

A management infrastructure 2 of a telecommunication network 4 is electrically powered by an electrical energy supplier 6 via an electrical grid 8.

As schematically shown in FIG. 1, the electric power supplied by the electrical energy supplier 6 can be generated using a variety of energy sources.

The energy sources used to generate electric power are usually classified into different types, or production channels, for example: oil, gas, nuclear, solar, hydraulic, wind.

According to a conceivable alternative, several electrical energy suppliers could electrically power the electrical grid 8.

The management infrastructure 2 is for example a core network (or backbone).

An exemplary embodiment of the invention for use with the 5G mobile telephony standard is described here. In this context, the core network is a 5G core network. The invention is however not limited to this context and can be applied to other telecommunication networks than those designed in accordance with the 5G standard.

The management infrastructure 2 is designed to implement various management functions for the telecommunication network 4, in particular an access and mobility management function (AMF).

The telecommunication network 4 also includes a radio access network that comprises an infrastructure unit 10, here a base station (of the gNodeB type in the 5G standard context used here by way of example).

In certain embodiments, the infrastructure unit 10 is also electrically powered by means of the electrical grid 8, as schematically shown in FIG. 1. However, as an alternative, the infrastructure unit 10 could be electrically powered by another electrical energy supplier and/or by means of another electrical grid.

The radio access network, and in particular the infrastructure unit 10, is designed to establish a radio link with user equipment within the range of the infrastructure unit 10. In FIG. 1 is shown only one such user equipment 20, which will be described in detail hereinafter.

The infrastructure unit 10 comprises a processor 12, a first communication unit 14 and a second communication unit 16.

The operation of the infrastructure unit 10 (in particular as described hereinafter) is implemented, for example, by the execution of computer program instructions by the processor 12 (wherein these instructions can be stored in a memory connected to the processor 12).

The first communication unit 14 is designed to establish a link with the core network 2. Within the framework of the 5G standard, this link is the interface N2 between the radio access network and the above-mentioned AMF function.

The second communication unit 16 is designed to establish the already-mentioned radio link with the user equipment 20.

The equipment 20 comprises a processor 22, a communication module 24 and a subscriber identification module 26.

The operation of the user equipment 20 (in particular as described hereinafter) is implemented, for example, by the execution of computer program instructions by the processor 22 (wherein these instructions can be stored in a memory connected to the processor 22).

The communication module 24 is designed to establish the already mentioned radio link between the infrastructure unit 10 (more precisely, the second communication unit 16) and the user equipment 20, i.e. a radio link with the telecommunication network 4.

The subscriber identification module 26 stores authentication data enabling the user equipment to connect to the telecommunication network 4 and to thus be able to exchange data with other equipment connected to the telecommunication network 4.

The subscriber identification module 26 can be implemented in practice by means of a microcircuit board (removable and which can be inserted into a suitable reader on the user equipment 20), or an integrated circuit fitted on the user equipment 20 and storing the above-mentioned authentication data.

An operation, administration and maintenance (or OAM) architecture 30 associated with the telecommunication network 4 performs various settings of the management infrastructure 2 (here the core network, and in particular the different functions implemented in this core network) in such a way as to ensure the smooth operation of the telecommunication network 4 and to evolve the operation of the telecommunication network 4 according to the choices of the telecommunications operator concerned.

Finally, a server 40 associated with the electrical energy supplier 6 prepares and can thus transmit data representative of the distribution, by type of production energy source (i.e. by type of energy source used for production), of the electric power produced by the electrical energy supplier 6.

As an alternative, the server 40 could be associated with the electrical grid 8 and could then prepare and transmit data representative of the distribution, by type of production energy source (i.e. by type of energy source used for production), of the electric power available on the electrical grid 8. In this case, these representative data can be prepared (i.e. here, in particular, synthesized) for example by the operator of the electrical grid 8 based on information provided by the different actors (electrical energy suppliers) electrically powering the electrical grid 8.

According to a possible embodiment, these representative data comprise, for each type of production energy source, the percentage of the total power (produced by the energy producer 6 or available on the electrical grid 8) that is produced thanks to an energy source of this type. In other words, these representative data comprise, for each type of production energy source, the relative weight of the electric power produced by this type of energy source in the total electric power produced by the electrical energy supplier 6 or available on the electrical grid 8.

When the different types used are oil, gas, nuclear, solar, hydraulic and wind, the representative data are for example a chain of characters (such as for example: O5G5N70S10H5W5), where the number following the letter O corresponds to the percentage of electric power produced by oil combustion, the number following the letter G corresponds to the percentage of electric power produced by gas combustion, the number following the letter N corresponds to the percentage of electric power of nuclear origin, the number following the letter S corresponds to the percentage of electric power of solar origin, the number following the letter H corresponds to the percentage of electric power of hydraulic origin, and the number following the letter W corresponds to the percentage of electric power of wind origin.

In other words, the representative data are for example formed by a chain of characters comprising, for each type of production energy source, i.e. for each production channel, a letter identifying the type of production energy concerned, followed with a number representing the relative weight of the electric power produced by this type of energy source in the total electric power produced by the electrical energy supplier 6 or available on the electrical grid 8.

According to a possible embodiment, the types of energy considered are: renewable energies and non-renewable energies.

The representative data can then comprise data representative of the electric power portion produced from renewable energies in the total electric power produced by the electrical energy supplier 6 or available on the electrical grid 8, and/or data representative of the electric power portion produced from non-renewable energies in the total electric power produced by the electrical energy supplier 6 or available on the electrical grid 8.

FIG. 2 is a flow chart showing a first example of a method according to the invention.

This method begins by a step E2 of transmitting the above-mentioned representative data from the server 40 to an electronic unit connected to the telecommunication network 4. The representative data are thus received by this electronic unit at step E2.

This electronic unit can be the user equipment 20 (in which case, this is in practice the communication module 24 that receives the representative data), the infrastructure unit (here, a base station) 10 (in which case, this is in practice the first communication unit 14 that receives the representative data), or an electronic unit of the management infrastructure (here the core network) 2, for example an electronic unit implementing the already mentioned AMF function.

Transmission of the representative data is made for example using the operation, administration and maintenance architecture 30, and possibly using one or more management function(s) for the telecommunication network 4 (management function implemented by the management infrastructure 2 as already indicated).

The method of FIG. 2 continues with a step E4 of testing, by the electronic unit, at least one condition relating to the distribution represented by the representative data received.

This test comprises for example determining if the electric power portion coming from fossil energies (portion indicated by the representative data) is higher than a predetermined threshold (for example, of between 5% and 40%, here 30%).

If the tested condition is met (or, as the case may be, the tested conditions are met), the method then comprises a step E6 of adapting the electronic unit operation.

In the example mentioned hereinabove, the electronic unit operation is adapted (in particular as proposed hereinafter) in the case where the electric power portion coming from fossil energies is higher than the predetermined threshold (and only in this case).

According to another possible embodiment, the electronic unit operation is adapted (in particular as proposed hereinafter) in the case where the electric power portion coming from non-renewable energies is higher than a predefined threshold (and only in this case).

According to still another possible embodiment, the electronic unit operation is adapted (in particular as proposed hereinafter) in the case where the electric power portion coming from renewable energies is lower than a predefined threshold (and only in this case).

The adaptation of the electronic unit operation can comprise, for example, postponing the execution of a task by the electronic unit. This postponed task can be a task of internal management of the electronic unit operation, a calculation task performed by the electronic unit or an updating of a software component of the electronic unit.

The task postponing is for example active as long as the condition tested as indicated hereinabove is met.

The adaptation of the electronic unit operation can comprise (as an alternative or in combination with what as been indicated) selecting a predefined algorithm to implement a given function.

For example, if a first cryptographic algorithm and a second cryptographic algorithm are available to perform a given cryptographic processing (or function), and if the use of the second cryptographic algorithm causes an electrical consumption (energy consumption) lower than that resulting from the use of the first cryptographic algorithm, the adaptation of the electronic unit operation can comprise selecting the second cryptographic algorithm (wherein the second cryptographic algorithm can, on the other hand, be sub-optimal for other criteria, such as for example the rapidity of execution).

The adaptation of the electronic unit operation can comprise (as an alternative or in combination with what has been indicated) modifying the location, within the telecommunication network, of buffers used by user equipment connected to the telecommunication network. The “edge computing” techniques involve locating buffers as close as possible to users. This aspect of the telecommunication network 4 operation can be adapted when the tested condition is met.

In the just-described examples, the adaptation of the electronic unit operation enables a reduced electrical consumption, adapted to the circumstances described by the representative data.

That is what is sought in the case where the test performed by the electronic unit indicates an unfavorable situation, in which power consumption is to be reduced.

The invention is however not limited to this type of operation: on the contrary, it can be provided that the test performed by the electronic unit determines if the situation is favorable (by verifying, for example, if the electric power portion coming from fossil energies is lower than the predefined threshold, or if the electric power portion coming from renewable energies is higher than a predefined threshold), and, if the tested condition is met, to adapt the electronic unit operation, for example by performing a particular task (such as an updating of a software component of the electronic unit).

According to another possible embodiment, the test can relate to the portion relating to a particular type of production energy source in order to deduce therefrom a possible particular situation (for example, meteorological). For example, it is possible to test the electric power portion of wind origin with respect to the total electric power (or the increase of this portion) and, in the event of a threshold being exceeded, to adapt the operation of one or more electronic units connected to the telecommunication network 4 in order to allocate more resources to help manage a potential storm.

Other examples of adaptation of the electronic unit operation are moreover given in the following of the description.

FIG. 3 is a flow chart showing a second example of a method according to the invention.

The method of FIG. 3 starts with a first preliminary step E10 of transmitting definition data that define at least one condition. The definition data are here transmitted from the management infrastructure 2 to the user equipment 20. These definition data can be transmitted among data of the control plane, for example via the AMF function and the interface N1 between this AMF function and the user equipment 20.

The method then comprises a second preliminary step E12 in which the definition data are received by the user equipment 20 and stored within the subscriber identification module 26. This step E12 is for example implemented due to the execution of a dedicated application by the processor 22.

The preliminary steps E10 and E12 are optional. As an alternative, the definition data could be stored in the subscriber identification module 26 during the manufacturing of the latter (case of a hardware subscriber identification module) or during the downloading of the latter (case of a software subscriber identification module).

As the following description will show, the definition data define at least one condition relating to the electric power distribution by type of production energy source, which condition is used later in the present method.

It is considered that, at a phase of the user equipment 20 operation (step E14), this user equipment 20 has established by means of the communication module 24 a radio link with the infrastructure unit 10, with the following characteristics:
the communication module 24 is designed to transmit electromagnetic waves with a first maximum transmission power (which corresponds for example to a nominal transmission power);
the processor 22 (or, as an alternative, the communication module 24) is designed to select a frequency band used for the radio link among an initial set of frequency bands (defined for example by the standard used);
the processor 22 (or, as an alternative, the communication module 24) is designed to select a network slice among a set of initial network slices available (defined, for example, by the infrastructure unit 10 and/or signaled within a message received by the user equipment 20 from this infrastructure unit 10).

The method of FIG. 3 then comprises a step E16 of transmitting, from the server 40 to the architecture 30, data representative of the distribution, by type of production energy source (i.e. by type of energy source used for production), of the electric power produced by the electrical energy supplier 6.

These representative data are then transmitted during a step E18 from the architecture 30 to the management infrastructure 2.

The management infrastructure 2 thus receives the representative data at step E20.

We describe here the case of data representative of the distribution, by type of production energy source, of the electric power produced by the electrical energy supplier 6. However, as already indicated, the representative data received by the management infrastructure 2 could also represent the distribution, by type of production energy source, of the electric power available on the electrical grid 8 (in which case, these representative data would have been produced by an operator of the electrical grid 8, as already explained).

During a step E22, the representative data are transmitted from the management infrastructure 2 (here, in particular from the AMF function) to the infrastructure unit 10 (here, a base station having established a communication with the user equipment 20). In the example described here, the transmission of the representative data between the AMF function and the infrastructure unit 10 (which is part of the radio access network) is made via the interface N2.

The infrastructure unit 10 can then transmit, at step E24, the representative data to the user equipment 20, here via the radio link established between the base station (used as an infrastructure unit 10) and the user equipment 20. The representative data are for example transmitted within a block of system information (transmitted from the infrastructure unit, here the base station 10, to the user equipment 20), such as a block of the SIBn type (with n between 1 and 20), for example within the block SIB1.

As an alternative, the representative data could be transmitted from the management infrastructure 2 (for example, from the AMF function) to the user equipment 20 via a communication channel (such as the already-mentioned interface N1) established between the management infrastructure 2 (here the AMF function) and the user equipment 20, for example within a NAS (“Non Access Stratum”) message. This communication channel passes physically through the infrastructure unit 10 but the data transmitted in the communication channel are not accessible by the infrastructure unit 10.

The user equipment 20 (i.e., in practice, the communication module 24) receives the representative data at step E26.

The user equipment 20 then proceeds to a test (step E28) to determine if the representative data received meet the condition defined by the definition data (stored, in the present example, in the subscriber identification module 26).

During this test step E28, the processor 22 of the user equipment 20 performs for example a comparison between certain at least of the representative data received and certain at least of the definition data so as to determine if the representative data received meet the above-mentioned condition.

For example, the processor 22 compares the electric power portion coming from fossil energies (portion indicated by the representative data) with a threshold defined by the definition data and considers here that the condition is met if the electric power portion coming from fossil energies is higher than this threshold.

As an alternative, the processor 22 could compare the electric power portion coming from non-renewable energies with a threshold defined by the definition data, and consider for example that the condition is met if the electric power portion coming from non-renewable energies is higher than this threshold.

According to another alternative, the processor 22 could compare the electric power portion coming from renewable energies with a threshold defined by the definition data, and consider for example that the condition is met if the electric power portion coming from renewable energies is lower than this threshold.

When the processor 22 determines that the representative data received met the above-mentioned condition, the processor 22 orders at step E30 an adaptation of the user equipment 20 operation.

The processor 22 configures for example at step E30 the communication module 24 so that the power transmitted (i.e. the power of the electromagnetic waves transmitted) by the communication module 24 is lower than a second maximum transmission power (this second maximum transmission power being strictly lower than the first previously-used maximum transmission power). This second maximum transmission power can be defined, or as an alternative, determined as a function of part at least of the representative data, for example as a function of the difference between the electric power portion coming from fossil energies (or, as the case may be, non-renewable energies) and the above-mentioned threshold.

The maximum transmission power of the user equipment 20 can thus be modified as a function of the distribution defined in the representative data received.

During step E30, the processor 22 can also determine a restricted set of frequency bands that could be used by the communication module 24 to establish the radio link with the telecommunication network 4 (here, especially with the infrastructure unit 10). The restricted set of frequency bands comprises one or several frequency band(s) of the initial set of frequency bands, but does not include at least one frequency band of the initial set (deemed too energy-consuming when the condition is verified).

The restricted set of frequency bands comprises for example one or several frequency band(s) whose spectrum is located (in totality) under 1 GHZ (one or several frequency band(s) whose spectrum is at least partly located above 1 GHz being in this case excluded from the restricted set).

In other words, the processor 22 prohibits the use by the user equipment 20 (in practice by the communication module 24) of at least one frequency band (yet included in the initial set of frequency bands and/or usable according to current standards), for example a frequency band whose spectrum is at least partly located above 1 GHz.

The frequency bands usable by the user equipment 20 to establish the radio link with the telecommunication network 4 (here especially with the infrastructure unit 10) are thus determined as a function of the distribution defined by the representative data received by the user equipment 20.

During step E30, the processor 22 can also determine a restricted set of network slices via which the user equipment 20 can access the telecommunication network 4. This restricted set of network slices comprises one or more network slice(s) of the initial set of network slices, but does not includes at least one network slice of this initial set.

In practice, the user equipment 20 (here the processor 22) receives for example (here from the user infrastructure 10) information indicating energy consumption respectively associated with the network slices and selects, as network slice(s) belonging to the restricted set, the network slice(s) (belonging to the initial set of network slices) for which the energy consumption respects a determined criterion (wherein this determined criterion can depend on representative data received). The network slices of the initial set of network slices for which the energy consumption does not respect the determined criterion are in this case excluded from the restricted set of network slices.

As an alternative, the selection of the network slices by the processor 22 could be made as a function of characteristics of each network slice, wherein these characteristics can be defined for example by the variable S-NSSAI (for “Single Network Slice Selection Assistance Information”) in the 5G standard example used here.

The processor 22 can then configure the communication module 24 so that the user equipment 20 accesses the telecommunication network 4 (using the communication module 24) via one of the network slices of the restricted set of network slices.

The user equipment 20 (under the control of the processor 22) thus determines the network slice via which this user equipment 20 accesses the telecommunication network 4 as a function of the distribution defined in the representative data received. During step E30, the processor 22 can also block (i.e. forbid) the use of certain services provided by the user equipment 20 thanks to the execution of instructions by the processor 22, such as video-related services (for example, a service for displaying video content via a display on the user equipment 20).

During step E30, the processor 22 can also restrict the use of certain services provided by the user equipment 20 thanks to the execution of instructions by the processor 22, for example by limiting the receipt and/or transmit data rate.

The services available for execution by the user equipment 20 (in practice by the processor 22) can thus be determined as a function of the distribution defined by the representative data received.

FIG. 4 is a flow chart showing a third example of a method according to the invention.

The method of FIG. 4 starts by a step E50 during which the user equipment 20 receives the representative data produced by the server 40.

The representative data can be transmitted from the server 40 to the user equipment 20 via the architecture 30 and the management infrastructure 2, for example as described hereinabove with reference to steps E16 to E26.

However, as an alternative, the representative data could be transmitted from the server 40 to the user equipment 20 in another way, for example by transiting via the Internet (the user equipment 20 being connected to the Internet either via the communication network 4, or via another system, such as a LAN (“Local Area Network”).

The method of FIG. 4 continues with a step E52 during which the user equipment 20 receives, for example from another server 50, other data representative of another distribution, by type of production energy source (i.e. energy source used for production), of the electric power powering at least partly another telecommunication network than the telecommunication network 4.

The other server 50 is for example associated with another electrical energy supplier than the electrical energy supplier 6, or with the operator of another electrical grid than the electrical grid 8, the other telecommunication network being powered at least partly by the other electrical energy supplier and/or via the other electrical grid.

These other representative data can for example be transmitted from the other server 50 to the user equipment 20, via the Internet, via the telecommunication network 4, or as an alternative, via another system, such as a local area network or LAN.

The processor 22 can then compare at step E54 the distribution defined by the representative data received from the server 40 and the other distribution defined by the other representative data, received from the other server 50.

The processor 22 thus performs a test about a condition relating not only the distribution defined by the representative data received from the server 40, but also to the other distribution defined by the other representative data.

This test comprises for example determining, by the processor 22, if the electric power portion coming from fossil energies (or, as an alternative, from non-renewable energies) as indicated in the representative data is higher (strictly, or as an alternative, by more than a predetermined number of points) than the electric power portion coming from fossil energies (or, in the alternative, from non-renewable energies) as indicated in the other representative data.

Other types of test (i.e. other tested conditions) can be contemplated in other embodiments.

The tested condition (i.e. the test) can relate for example to a comparison between an electric power portion coming from renewable energies as indicated by the representative data and an electric power portion coming from renewable energies as indicated by the other representative data.

In this case, the condition is met for example when the electric power portion coming from renewable energies as indicated in the representative data is lower (strictly, or as an alternative, by more than a predetermined number of points) than the electric power portion coming from renewable energies as indicated by the other representative data.

The test performed by the processor 22 at step E54 can (seek to) verify several distinct conditions, for example:
if the electric power portion coming from fossil energies (or as an alternative: coming from non-renewable energies) as defined in the representative data is higher than a predetermined threshold;
if the electric power portion coming from fossil energies (or as an alternative: coming from non-renewable energies) as defined in the representative data is higher (possibly: by more than a predetermined number of points) than the electric power portion coming from fossil energies (in the alternative: from non-renewable energies) as indicated in the other representative data.

When the condition is met (or, if several conditions are used, when the conditions are met), the processor 22 adapts the operation of the user equipment 20 by controlling the communication module 24 to connect to the other telecommunication network (step E56).

On the other hand, if the condition is not met (or, if several conditions are used, when at least one condition is not met), the user equipment 20 remains connected to the telecommunication network 4 (or, as the case may be, for example when the representative data have been received via a local area network, the processor 22 controls the communication module 24 to connect to the telecommunication network 4).

The user equipment 20 is then connected to the telecommunication network 4 or to the other telecommunication network as a function of the distribution defined by the representative data and of the other distribution defined by the other representative data.

FIG. 5 is a flow chart showing a fourth example of a method according to the invention.

The method shown in FIG. 5 comprises a step E100 of receiving representative data by the first communication unit 14 of the infrastructure unit 10.

These representative data have been produced by the server 40, as already indicated, and can for example be transmitted to the infrastructure unit 10 via the architecture 30 and the management infrastructure 2. The method comprises for example in this case steps identical to steps E16 to E22, previously to step E100.

The method of FIG. 5 then comprises a step E102 of testing, by the infrastructure unit 10 (i.e., in practice, by the processor 12), a condition relating to the distribution defined by the representative data received at step E100.

The processor 12 determines for example by this test step E102 if the electric power portion coming from fossil energies is higher than a predetermined threshold.

The processor 12 then establishes at step E104 a list of network slices according to the result of the test step E102 and thus as a function of the distribution defined by the representative data.

For example, when the condition is met in the test step E102, the list established by the processor 12 contains only network slices whose characteristics allow a reduced consumption of electricity (energy consumption). To perform this selection of the network slices present in the list, the processor 22 uses for example characteristics of each network slice as defined for example by the variable S-NSSAI (for “Single Network Slice Selection Assistance Information”) in the 5G standard example used here. These characteristics can for example be at least one latency characteristic and/or at least one security characteristic and/or at least one antenna processing characteristic and/or at least one power characteristic and/or at least one multiplexing mode characteristic (for example, FDD for “Frequency Division Duplex” or TDD for “Time Division Duplex”) and/or one flow rate (bandwidth) characteristic. For example, when the condition is met in the test step E102, only the network slices having an authorized latency higher than a latency threshold and/or a bandwidth lower than a bandwidth threshold are selected in the list.

As explained in the following, the network slices of the list are those the user equipment will be able to use for connecting to the network.

The method of FIG. 5 then comprises a step E106 of transmitting the list established at step E104 from the infrastructure unit 10 to the user equipment 20. The list is here transmitted by means of the radio link established between the second communication unit 16 of the infrastructure unit and the communication module 24 of the user equipment 20.

The user equipment 20 receives the list of network slices at step E108.

The user equipment 20 (i.e. here the processor 22) can then select a network slice among the network slices of the list (step E110).

The processor 22 can then control the communication module 24 to access the telecommunication network 4 via the selected network slice (step E112). The user equipment 20 thus accesses the telecommunication network 4 via the selected network slice.

As the list has been determined (and restricted in the case where the condition is met) by the processor 12 of the infrastructure unit 10, the user equipment 20 can chose the network slice used only in this list; the transmission of the list to the user equipment 20 thus causes an adaptation of the user equipment 20 operation, here so as to use only less energy-consuming network slices when the condition relating to the distribution defined by the representative data is met.

1. A method implemented in a telecommunication network including at least one management infrastructure electrically powered by at least one electrical energy supplier via an electrical grid, the method comprising:
receiving, by an electronic device connected to the telecommunication network, data representative of a distribution, by type of production energy source, of electric power produced by the at least one electrical energy supplier or available on the electrical grid;
testing, by the electronic device, at least one condition relating to said distribution; and
adapting operation of the electronic device or operation of another electronic device connected to the telecommunication network, when the at least one condition is met.

2. The method according to claim 1, wherein the electronic device is a user equipment configured to establish a radio link with the telecommunication network, and wherein the adapting comprises adapting the user equipment.

3. The method according to claim 2, further comprising:
receiving, by the electronic device, other data representative of another distribution, by type of production energy source, of an electric power at least partly powering another telecommunication network; and
connecting the electronic device to the telecommunication network or to the other telecommunication network as a function of said distribution and said other distribution.

4. The method according to claim 2, wherein the frequency bands usable by the electronic device to establish said radio link are determined as a function of said distribution.

5. The method according to claim 2, wherein the electronic device determines a network slice via which the electronic device accesses the telecommunication network as a function of said distribution.

6. The method according to claim 2, wherein a maximum transmission power of the electronic device is modified as a function of said distribution.

7. The method according to claim 2, wherein services available for execution by the electronic device are determined as a function of said distribution.

8. The method according to claim 2, wherein the representative data are received by the electronic device within a block of system information.

9. The method according to claim 2, wherein the electronic device is equipped with a subscriber identification module configured to store data indicative of said at least one condition.

10. The method according to claim 1, wherein the electronic device is an infrastructure device of the telecommunication network.

11. The method according to claim 10, wherein the electronic device is designed to establish a radio link with at least one user equipment.

12. The method according to claim 11, further comprising:
establishing, by the electronic device and as a function of said distribution, a list of network slices usable by the at least one user equipment; and
transmitting said list of network slices from the electronic device to the at least one user equipment.

13. The method according to claim 1, wherein the electronic device is configured to transmit to the other electronic device data causing an adaptation of the operation of the other electronic device, when said at least one condition is met.

14. The method according to claim 1, wherein the adapting comprises postponing execution of a task when said at least one condition is met.

15. The method according to claim 14, wherein said task is an updating of a software component of the electronic device.

16. The method according to claim 1, wherein the adapting comprises selecting a predefined algorithm to implement a specific functionality.

17. The method according to claim 1, wherein the adapting comprises modifying a location, within the telecommunication network, of buffers used by user equipment connected to the telecommunication network.

18. The method according to claim 1, wherein said at least one condition is met when said distribution indicates that an electric power portion obtained from fossil energies is higher than a predetermined threshold.

19. The method according to claim 1, wherein said at least one condition is met when said distribution indicates that an electric power portion derived from wind is higher than a predetermined threshold.

20. The method according to claim 1, wherein said representative data are transmitted by a server associated with one of the electrical energy supplier and the electrical grid.

21. The method according to claim 1, wherein said representative data are transmitted through an operation, administration and maintenance architecture associated with the telecommunication network.

22. The method according to claim 1, wherein said representative data are transmitted through at least one management function that is configured to manage the telecommunication network.

23. An electronic device comprising:
a communication device configured to establish a link with a telecommunication network comprising at least one management infrastructure electrically powered by at least one electrical energy supplier via an electrical grid, and to receive data representative of a distribution, by type of production energy source, of electric power produced by the at least one electrical energy supplier or available on the electrical grid; and
an adaptation circuitry configured to test at least one condition relating to said distribution and to adapt, when said at least one condition is met, operation of the electronic device.

24. The electronic device according to claim 23, wherein said electronic device is a user equipment, and
wherein the communication device is configured to establish a radio link with the telecommunication network.

25. An electronic device comprising:
a communication device configured to establish a link with a telecommunication network comprising at least one management infrastructure electrically powered by at least one electrical energy supplier via an electrical grid, and to receive data representative of a distribution, by type of production energy source, of electric power produced by the at least one electrical energy supplier or available on the electrical grid; and
adaptation circuitry configured to test at least one condition relating to said distribution and to control, when said at least one condition is met, a transmission, to another electronic device connected to the telecommunication network, of data causing an adaptation of operation of the other electronic device.
